(19) United States
(12) Patent Application Publication
(10) Pub. No.: US 2020/0009690 A1
(43) Pub. Date: Jan. 9, 2020

(54) Laser processing hydrogel materials

(71) Applicant: Preco, Inc., Somerset, WI (US)

(72) Inventors: Kimberly Hill, South St. Paul, MN (US); Alexandra Swanson, Somerset, WI (US); Daniel B. Miller, Roberts, WI (US); Ken Arvey, Emerald, WI (US)

(21) Appl. No.: 16/503,018

(22) Filed: Jul. 3, 2019

Related U.S. Application Data
(60) Provisional application No. 62/694,204, filed on Jul. 5, 2018.

(51) Int. Cl. B23K 26/384; B23K 26/06; B23K 26/402

(52) U.S. Cl. CPC B23K 26/384; B23K 2101/18; B23K 26/402; B23K 26/06

(57) ABSTRACT

A method of forming one or more perforations, holes, or capillaries in a hydrogel material, hydrocolloid material, hydrogel adhesive or silicone adhesive comprising directing a focal point of a laser beam to a surface of the material or adhesive at one or more locations to form one or more perforations, holes, or capillaries having a selected diameter. The perforated hydrogel material or adhesive can be used in wound care dressings, wearable sensors, or devices intended to contact living tissue. The perforated material or adhesive may also be provided in contact with an exudate holding mechanism such as an open cell foam material to further increase the exudate absorbance of the hydrogel or hydrocolloid wound care dressing.

### CROSS REFERENCE TO RELATED APPLICATIONS

The present application is based on and claims the benefit of U.S. provisional patent application Ser. No. 62/694,204, filed Jul. 5, 2018, the content of which is hereby incorporated by reference in its entirety

### BACKGROUND

Wound care dressings absorb wound exudates and fluids to encourage healing of the wound. Hydrogels have been used in wound care dressings and help regulate the fluid exchange on an external surface of the wound. Compounds from the hydrogel that assist in healing the skin layers, veins and tissues are exchanged with sodium and other discharge from the wound.

Water and fluids losses from wounded skin are almost 20 times greater than water loss through normal, intact skin. Thus, the water permeability of dressings should control the extensive dehydration as well as building up of exudates and scabs, without affecting the epithelialization or cell proliferation processes, as provided by hydrogels.

Hydrogels are vastly hydrophilic macromolecular networks which are produced by chemical or physical crosslinking of soluble polymers. Hydrogels can swell and de-swell water in a reversible direction. Hydrogels have been used in wound dressing materials, showing optimal conditions for healing burns and other surface wounds.

Holes have been formed in hydrogel sheets for use as wound dressings. The prior art methods of forming holes are so called “contact” methods, in that an instrument contacts the hydrogel material to form a hole. As described in U.S. Pat. No. 5,076,265, holes may be drilled out of the hydrogel sheet using hollow needles or syringes, or they may be formed by casting the hydrogel sheets in molds having a series of upward projections such that on removal of the sheets from the mold, appropriate holes are made.

Additionally, hydrogel adhesives are produced by filling the hydrogel with nanoparticles. The hydrogel adhesives are used in wound care dressings having increased adherence to the surface of the wearer's skin. These adhesive hydrogels can remain adhered to the skin surface, even if the wearer is sweating or exposed to other moisture. Traditional wound care dressings lose their ability to stick to skin in the presence of water; however adhesive materials based on hydrogels overcome this problem. The hydrogel adhesives are generally filled with nanoparticles made from materials like polystyrene. The adherent hydrogel material is “tacky” or “sticky,” thus inhibiting the ability to further increase the absorption of the hydrogel dressing by preventing contact methods from easily forming holes in the material.

### DESCRIPTION OF THE DRAWINGS

FIG. 1 is a picture of a silicone adhesive material laser processed to form varying holes and shapes according to methods described herein.

FIG. 2 is a picture of a polyurethane foam having an adhesive backing and laser processed to form varying holes and shapes according to methods described herein.

FIG. 3 is a picture of a silicone adhesive, hydrogel having a scrim and polyurethane foam laser processed to form varying holes and shapes according to methods described herein.

FIG. 4 is a picture of a hydrogel material having a scrim and laser processed to form varying holes and shapes according to methods described herein.

FIG. 5 is a picture of a polyurethane foam laser processed to form protrusions, or standing bosses, according to methods described herein.

FIG. 6 is a picture of a hydrogel material laser processed to form hydrogel “donuts” according to methods described herein.

FIG. 7 is a picture of a silicone adhesive laser processed to form varying holes and shapes according to methods described herein.

FIG. 8 is a micrograph of holes formed in a hydrogel material using a prior art method.

FIG. 9 is a micrograph of a hole formed in a hydrogel material using a laser beam according to methods described herein, wherein the holes are approximately 50 micron in diameter.

FIG. 10 is a micrograph of holes formed in a hydrogel material using a laser beam according to methods described herein, wherein the holes are approximately 50 micron in diameter.

FIG. 11 is a micrograph of a hole formed in a hydrogel material by a pin method of the prior art wherein the hole is closing naturally due to the method of formation and the material tendency to reflow or refill.

FIG. 12 is a micrograph of a hole formed in a hydrogel material by a pin method of the prior art wherein the hole is closing naturally due to the method of formation and the material tendency to reflow or refill.

FIG. 13 is a micrograph of a hole formed in a hydrogel material by a laser beam according to methods described herein and wherein the hole has been compressed or “squished” and the resistance of the hole to deformation is illustrated.

### SUMMARY

An aspect of the present disclosure relates to a method of forming one or more perforations, holes, or capillaries, in a hydrogel material using a laser beam to ablate the surface of the hyrdogel material.

Another aspect of the present disclosure relates to a method of directing a laser beam to a surface of a hydrogel adhesive material and forming one or more capillaries in the hydrogel adhesive material wherein the hydrogel adhesive material can be used in a wound care dressing.

Yet another aspect of the present disclosure relates to a method of forming one or more perforations, holes, or capillaries in an adhesive material comprising directing a focal point of a laser beam to a surface of the adhesive material and vaporizing the adhesive material at one or more locations to form one or more perforations, holes, or capillaries having a selected diameter.

Another aspect of the present disclosure relates to a method of forming one or more perforations, holes, or capillaries in a material in a non-contact manner which comprises directing a focal point of a laser beam to a surface of the material and vaporizing the material at one or more locations to form one or more perforations, holes, or capillaries having a selected diameter, wherein the material is one of a hydrogel material, a hydrocolloid material, or a silicone adhesive.

In any one of the embodiments described herein the hydrogel material or hydrogel adhesive having one or more capillaries formed by the laser beam may come in contact with an exudate holding mechanism in the wound care dressing.

In any one of the embodiments described herein the material comprises a wound care dressing or component, or a body contact sensor.

In any one of the embodiments described herein the laser energy of the laser beam is sufficient to cauterize the material when forming the one or more perforations, holes, or capillaries such that the one or more perforations, holes, or capillaries substantially retain their laser processed shape and diameter and resist closing or otherwise prevent the flow of the material from closing the one or more perforations, holes, or capillaries.

In any one of the embodiments described herein the adhesive material is one of a hydrogel adhesive or a silicone adhesive. A wound care dressing comprising the perforated adhesive can be provided. The wound care dressing comprising the perforated adhesive may be in contact with an exudate holding mechanism. The exudate holding mechanism is an open cell foam material such as polyurethane foam.

Yet another aspect of the present disclosure relates to a method of cauterizing a material with a laser beam for forming one or more perforations, holes, or capillaries in the material in a non-contact manner comprising directing a focal point of a laser beam to a surface of the material and vaporizing the material at one or more locations to form one or more perforations, holes, or capillaries having a selected diameter, and cauterizing a perimeter of the one or more perforations, holes, or capillaries so that the one or more perforations, holes, or capillaries retains its shape and diameter, wherein the material is one of a hydrogel material, a hydrocolloid material, or a silicone adhesive.

When processing the hydrogel material or hydrogel adhesive, the laser beam wavelength may range from about 5 micron to about 10 micron or greater. For example, if a CO₂ laser is used, the wavelength may be set to about 5 micron and used to produce holes having a diameter of about 85 micron or less than 85 micron in diameter. If a CO₂ laser is used, the wavelength may be selected from one of about 10.6 micron, about 10.2 micron and about 9.36 micron to produce holes in the material having a diameter greater than about 85 micron or a diameter less than about 85 micron. The diameter of the hole produced by laser processing according to the methods described herein is selected and may be as small as about 35 micron.

### DETAILED DESCRIPTION

A method of laser processing a material that forms a gel in water, such as a hydrogel or a hydrocolloid material, to form one or more capillaries in the material is described herein. While the disclosure that follows is directed to a hydrogel material as described, the methods and systems described herein can also be applied to additional gel or like materials, including but not limited to silicone adhesives, hydrocolloids, polyurethane (“PU”) films and PU foams. The materials may be processed according to the methods described herein for use in wound care dressings and/or other devices including but not limited to body contact sensors.

In one embodiment, a laser processing system directs a laser beam toward a surface of the hydrogel material to produce one or more capillaries therein. What is meant by capillary as used throughout this disclosure is an elongated tube-like structure. Also included within the term capillary are other structures which may be formed in the hydrogel material using the laser beam, including but not limited to, holes having a selected diameter, perforations, wells or reservoirs, or the hydrogel may otherwise be cut or shaped by the laser beam.

Laser processing, for example, includes scoring and/or perforating the material as well as the production of capillaries, wells or reservoirs in a material. The material as referred to hereinafter may be a hydrogel material or a hydrogel adhesive as described in further detail below. Again, as noted above, the material may also be a hydrocolloid or an absorbent and/or adherent material such as a silicone adhesive. The laser beam energy and laser processing system optics are selected to ablate the material in a target area (e.g., an area on the surface of the material at or near the laser beam focal point) to a depth equal to, or less than the thickness of the material depending on the ultimate use of the material. Thus, the laser beam may be used to form perforations, holes, or reservoirs in a material, where the perforations or the reservoirs also have a selected diameter.

In further detail, a laser processing system referred to herein is a system for processing (e.g., perforating, scoring, or cutting) a material through the use of laser beam technology. Lasers provide a very efficient method of cutting, scoring, perforating or otherwise preparing selected materials for various end uses over the old mechanical systems, which may include die systems or pin type roller perforators. Lasers cut, score, or perforate the material through the use of a collimated amplified beam of light that terminates in a focal point. It is at or near the focal point of the beam that processing typically occurs. Intense energy at the focal point processes the material in what can be described as essentially a vaporizing, burning or ablating process. The method of processing the hydrogel materials described herein is a “non-contact” method where, for example, capillaries are formed in the hydrogel material without a physical component contacting or disturbing the hydrogel material. This is in contrast to the prior art methods of altering the structure of the hydrogel material with a physical cutting or molding process.

The prior art methods of altering the structure of gel materials and adhesives is limited to forming holes of a large diameter (e.g., greater than 500 micron) and these holes generally de-form or re-fill when formed in a gel material. Further, the mechanical components for cuttings these gel and adhesive materials tend to quickly accumulate the gel or adhesive material thereon as it sticks to the surface of the cutter. In contrast, the methods and systems described herein ablate away or cauterize the material to form a stable hole and the laser method also produces a so-called “gap” around the cut profile of the hole. That is, there is a clearance around the hole that the hole retains its shape and does not refill with the gel material.

The laser energy is focused on a surface of the material to vaporize a hole in the material. The laser processing system comprises a focusing lens for focusing the laser energy on the material surface. The diameter of the hole produced is generally directly related to the diameter of the focused spot of the laser in combination with how well the material “reacts” to the wavelength of the laser beam. What is meant by “reacts” is the ability of the material to absorb light or heat at the selected wavelength.

An assembly for laser processing the material as described herein comprises a laser source in communication with optics for directing the beam or multiple beams to the material for processing. The material for processing may also be referred to herein after as a “substrate.” The substrate may be stationary during laser processing, while the laser beam moves to produce one or more holes or perforations etc. in the substrate. Additionally or alternatively, the substrate may be a moving web such that the substrate moves through the laser assembly during laser processing. This allows a web of substrate to be processed continuously while passing below the laser beam concurrently during processing to produce a plurality of holes, perforations or capillaries on the substrate. The substrate can have a varying thickness and may or may not include a “scrim” or substrate to add strength and/or structure to the hydrogel or other material being laser processed.

A focal point(s) of the laser beam(s) is/are directed to a surface of the substrate using a process referred to as “camming”, which requires controlling and directing the laser beam(s) for precision perforation (or scoring) along a selected pattern. A controller sends commands to the laser processing assembly to direct and pulse the laser beam(s) precisely as the substrate is positioned for processing (whether the substrate is stationary or moving) to perforate or otherwise process the substrate according to the selected pattern. The pattern may comprise rows and/or columns of aligned perforations, random patterns of perforations. The laser beam(s) may be pulsed when processing the substrate to produce one or more capillaries, holes, perforations or reservoirs.

The laser assembly may comprise, for example, a CO laser, a CO₂ laser or other lasers and/or laser wavelengths (e.g., UV wavelength) for producing the holes in the materials described herein. The laser system and settings are selected based on the construction of the material being processed. For example, a laser wavelength is selected based on its ability to ablate or cauterize the selected material composition, the material thickness, and the hole diameter and wall size selected. When processing the hydrogel material or hydrogel adhesive, the laser beam wavelength may range from about 5 micron to about 10 micron or greater. For example, if a CO laser is used, the wavelength may be set to about 5 micron and used to produce holes having a diameter of about 85 micron or less than 85 micron in diameter. If a CO₂ laser is used, the wavelength may be selected from one of about 10.6 micron, about 10.2 micron and 9.36 micron to produce holes in the material having a diameter greater than about 85 micron or a diameter less than about 85 micron. The diameter of the hole produced by laser processing according to the methods described herein is selected and may be as small as about 35 micron. The diameter of hole in which the laser beam can be produced is smaller than the holes formed by conventional methods of forming holes in a hydrogel for example (e.g., a diameter less than the diameter of holes formed by mechanical cutting processes such as die cutting, pin type rollers etc.).

The methods described herein utilize a laser beam to ablate or cauterize the hydrogel or other material to form the hole. When a hole is mechanically formed in a hydrogel that is about 90% water, the material tends to re-form or re-fill such that the hole is prone to closing up or shrinking. The holes formed by the prior art methods tend to occlude after formation. However, when using the method as described herein, the holes are formed by ablating the material which prevents and substantially eliminates the re-flow and the holes formed are retained in shape and diameter.

The methods and assemblies described herein include producing articles made from hydrogel materials, hydrogel adhesive materials or the other materials described herein, such as wound care dressings or other devices commonly used in wound management, wound care, and other fields where hydrogel materials can be used. For example, the materials can be processed according to the methods described herein and incorporated into body contact sensors, or other electronic circuits and devices as the materials have a water concentration that allows the materials to conduct electricity. For example the method of this disclosure may be used to form via holes in such electronic circuits or devices. The disclosure, assembly and methods described herein can be used in substantially the same manner to perforate, score, cut, or produce capillaries, wells or reservoirs in the material regardless of the term used in describing the method or assembly.

In one embodiment, the hydrogels processed by the methods and assembly described herein may be synthesized by chemical crosslinking of acrylamide and methylene-bis-acrylamide including polysaccharides. Hydrogels can also be synthesized from crosslinked hydrophilic polymers, e.g. polyvinyl alcohol, polyvinyl pyrrolidone, or polyethylene oxide. There are various types of hydrogels which can be used as polymeric dressings, including those based on natural polymers such as chitosan, glucan, alginates, and hyaluronan, those based on a combination of biopolymers and/or synthetic polymers including PVA-biopolymer composite membranes, and those based on PVA-nanoparticles-composite membranes or other nanoparticle composite membranes which produce a hydrogel adhesive.

The hydrogel materials described herein are those that can absorb and retain the wound exudates, which promote fibroblast proliferation and keratinocyte migration. The tight mesh size of hydrogel structures protects the wound from infection and prevents microorganisms and bacteria from entering the wound. Although hydrogels are made with or from a variety of different compounds, hydrogels are usually considered to be about 90 percent water that is suspended in a gel base. The hydrogel is thus mostly water in a hydrophilic polymer matrix. The hydrogel assists in providing the appropriate amount of moisture to the wound while absorbing exudate to assist the wound with healing.

The hydrogel materials are also conductive materials such that the materials processed according to this disclosure can also be incorporated into other devices such as sensors or body contact sensors.

The hydrogel material or hydrogel adhesives are compounds that are primarily comprised of water suspended in a gel base, such as a compound comprising about 80% or greater water, or about 90% or greater water, where the water is suspended in a polymeric matrix or gel base.

Further, the materials processed with the assembly and/or according to the methods described herein include adhesive materials such as silicone adhesives and/or hydrogel adhesives. Hydrogel adhesives are hydrogels having an increased ability to adhere (e.g., stick) to the wearer's skin. Nanoparticles may be incorporated in to the hydrogel to increase the adherence of the dressing to skin, especially for athletic applications or wherein the skin is prone to sweat.

Many hydrogel wound care dressings comprise glycerin and water as glycerin attracts, holds, and binds water to itself and when incorporated into a wound care dressing, binds water into the dressing. Polymerical hydrogel membranes may also be used for wound care dressings and include PVA-based hydrogel dressings. Polymers used in hydrogels include chitosan, dextran, alginate/gelatin and collagen/glycosaminoglycan. Other materials may include custom polypeptides, and blends such as chitosan/sodium alginate/poly(vinyl acetate).

The hydrogel material, including adhesives processed according to the methods described herein may be provided in various configurations for laser processing. These configurations include but are not limited to amorphous masses of hydrogel material which are conformable to the shape of a wound or substrate, hydrogel sheets, and hydrogel impregnated substrates (e.g. gauze, rope, non-woven sponge). The hydrogel materials may also be incorporated into devices having one or more layers and/or one or more layers of the device comprise an exudate holding mechanism, such as a polyurethane foam or like material. The hydrogel materials may also be cut and shaped with the laser method and systems described herein for incorporation into other devices as a conductive and/or absorbent material.

A laser perforated hydrogel material or hydrogel adhesive material incorporated into a dressing for a wound increases the ability of the dressing to handle exudate and move the exudate away from contact with the external surface of the wound or the skin of the wearer. What is meant by exudate is generally a fluid composed of serum, fibrin and/or white blood cells having leaked into air by exposed tissues or other fluid exuded from the area near or at the wound.

The method of laser processing described herein produces capillary openings in the hydrogel, hydrocolloid, or adhesive material that can transport the exudate absorbed by the hydrogel away from the wound area. The exudate may then be transported through the capillaries as noted previously. The exudate holding mechanism may be a polyurethane foam or like material incorporated into the dressing. The dressing may comprise a layer of such holding mechanism in contact with the laser perforated hydrogel material or adhesive. In addition, holes or pockets in the hydrogel or adhesive material can increase holding capacity of the hydrogel material when compared to a non-perforated hydrogel or other non-perforated wound care or dressing materials.

Laser perforating the hydrogel, hydrocolloid or adhesive material can also prolong the wearability of the dressing or wound care device in which the hydrogel is incorporated. By perforating the material, a Moisture Vapor Transmission Rate (MVTR) of the dressing or wound care device is increased. Increasing the MVTR in dressings or wound care devices has been proven to extend the duration the dressing or device can be in contact with or worn on the skin surface. This is further increased in the dressing utilizing the hydrogel adhesive and adherence is increased.

Laser processed hydrogels according to the present disclosure also have an added advantage of being perforated and/or shaped into configurations not possible using traditional methods. These traditional methods in addition to those described previously in this application include flatbed or rotary die presses for cutting, perforating or shaping the material.

Hydrogel materials generally tend to, or are designed to, stick to things on contact or covered with. This is further increased in the hydrogel adhesive or silicone adhesive materials. Because nanoparticles can be incorporated into the hydrogel materials to form the hydrogel adhesive and to increase the adherent properties of a hydrogel dressing for prolonged use, the materials have increased tackiness or stickiness. These sticky materials are difficult to perforate with traditional methods. Due to the non-contact nature of digital laser processing the material as described herein, the adherent or sticky nature of the hydrogel material and adhesives is not a limiting factor in selecting the diameter of the capillary or perforation produced by the laser beam. For example, the sticky nature of the hydrogel material limits the size of the perforations (preventing small perforations such as capillaries, which are hair-like (e.g., on the order of less than 100 micron) in diameter from being made) and limits the thickness (preventing thin walls from being formed) of a wall section that can be manufactured.

As noted briefly above, the diameter of a hole that can be formed by the laser methods and systems described herein and the wall thickness depends on a balance of the laser beam type and/or wavelength, the thickness of the material being processed, the composition of the material being processed (e.g., does it absorb the wavelength or transmit the wavelength) and the desired hole dimeter. Prior art methods are carried out on thicker materials and the holes are larger. In the instant disclosure, the materials processed can be thinner (reduced thickness) and the hole diameter reduced. For example, in a thinner material a hole as small as about 35 micron can be produced having a wall (thickness/depth) as small as about 500 micron.

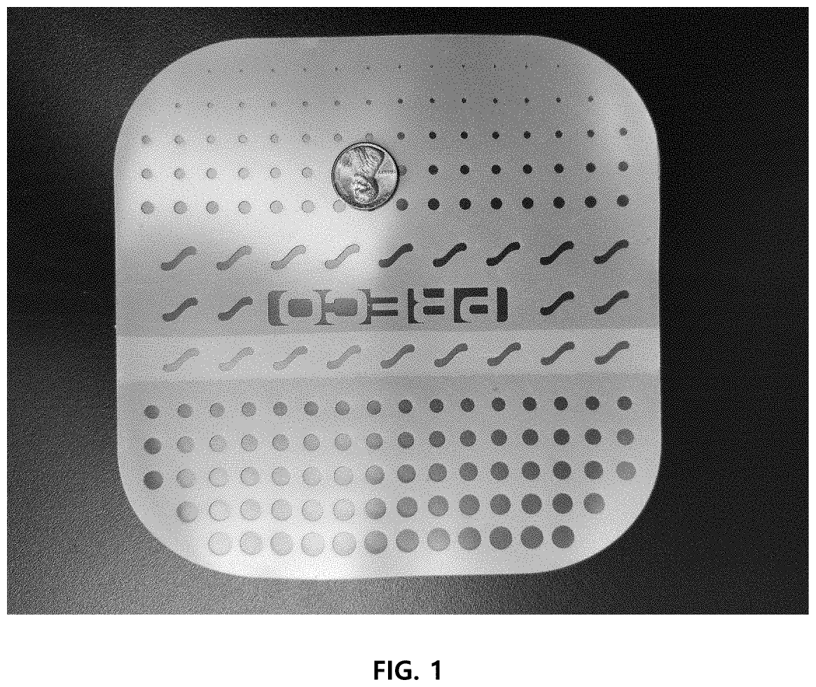

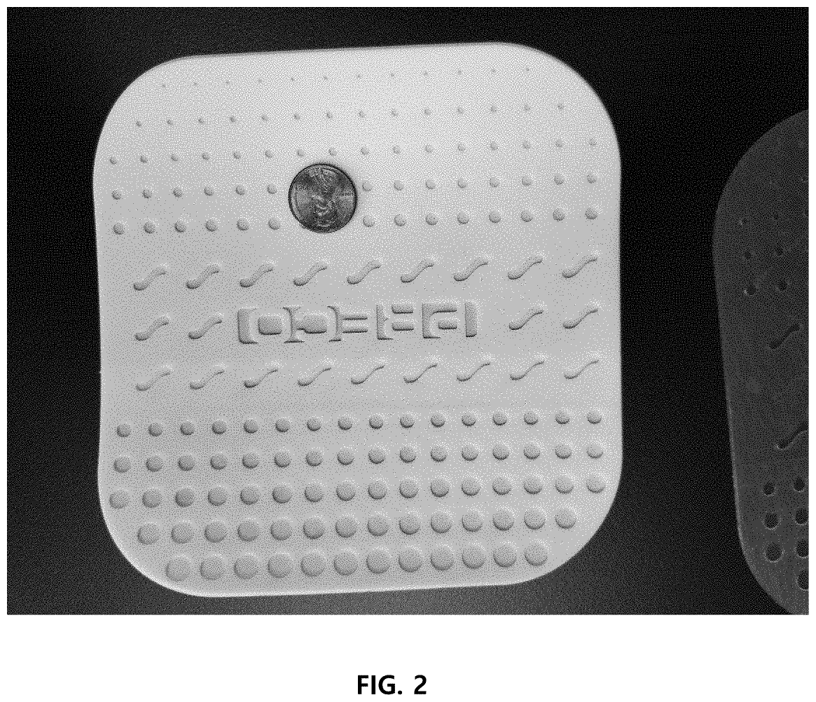

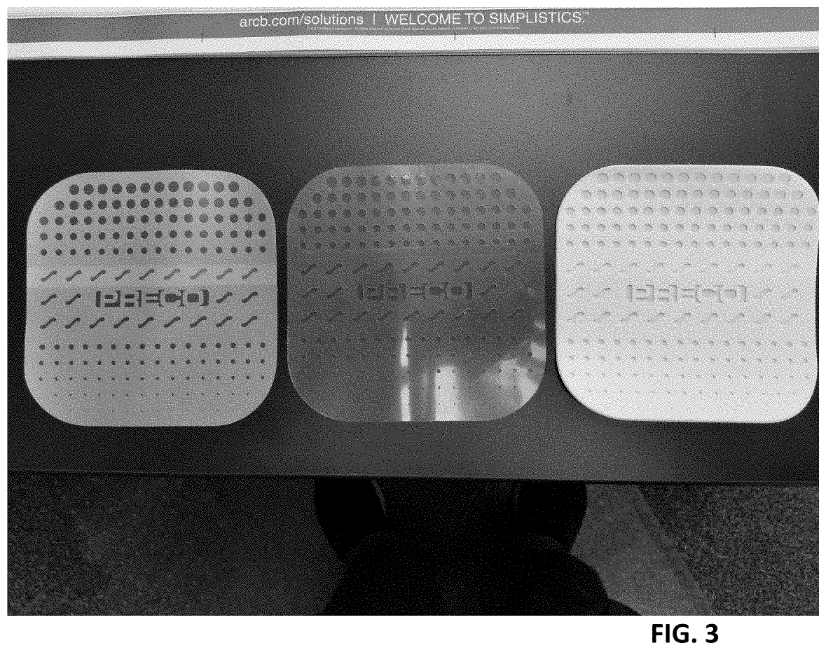

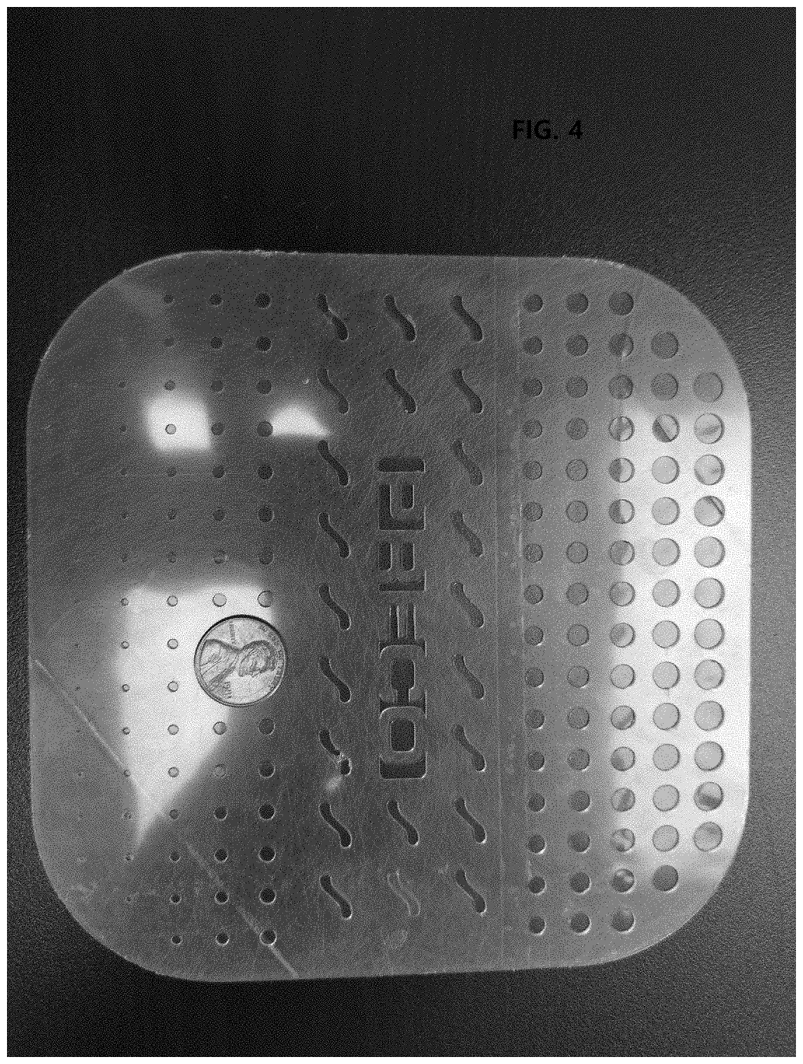

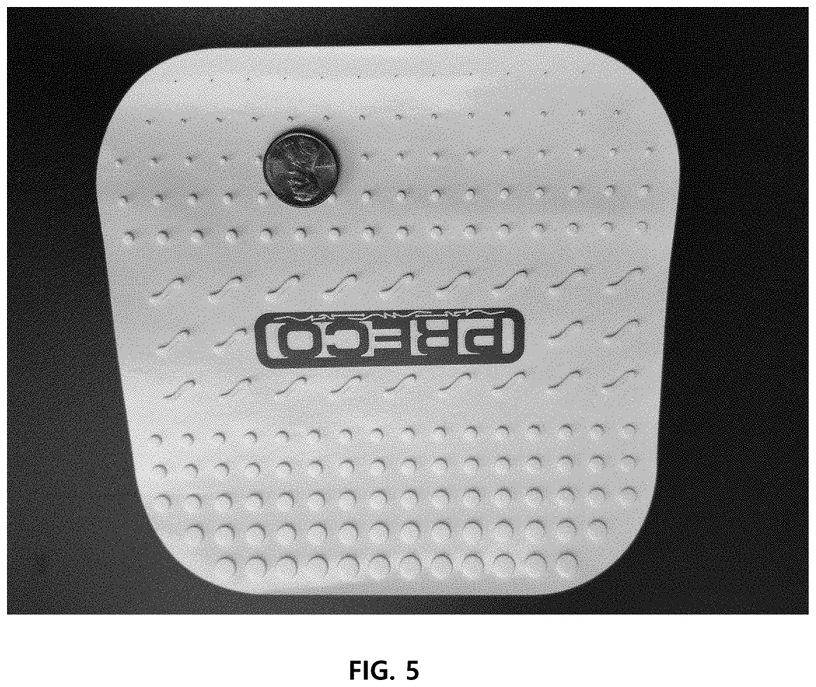

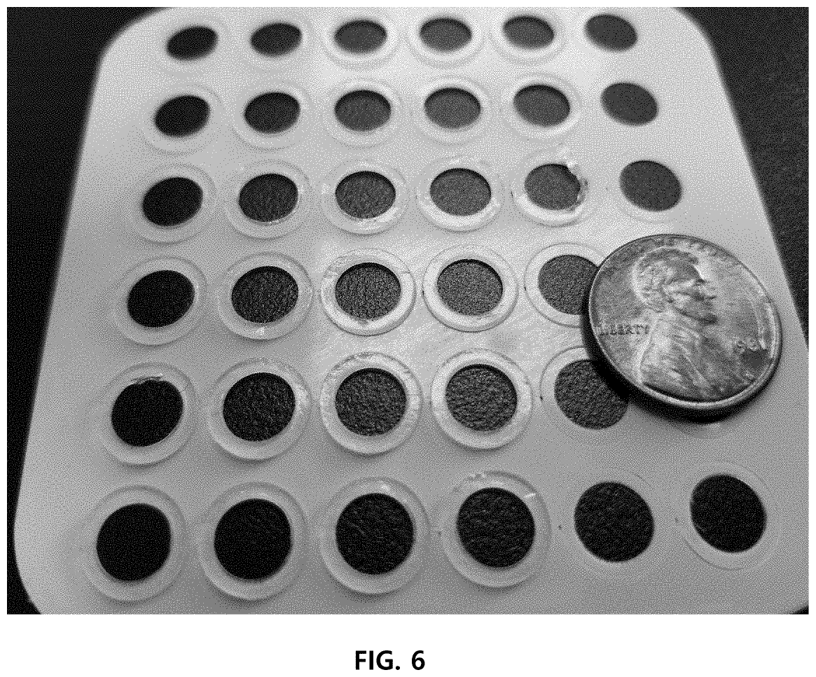

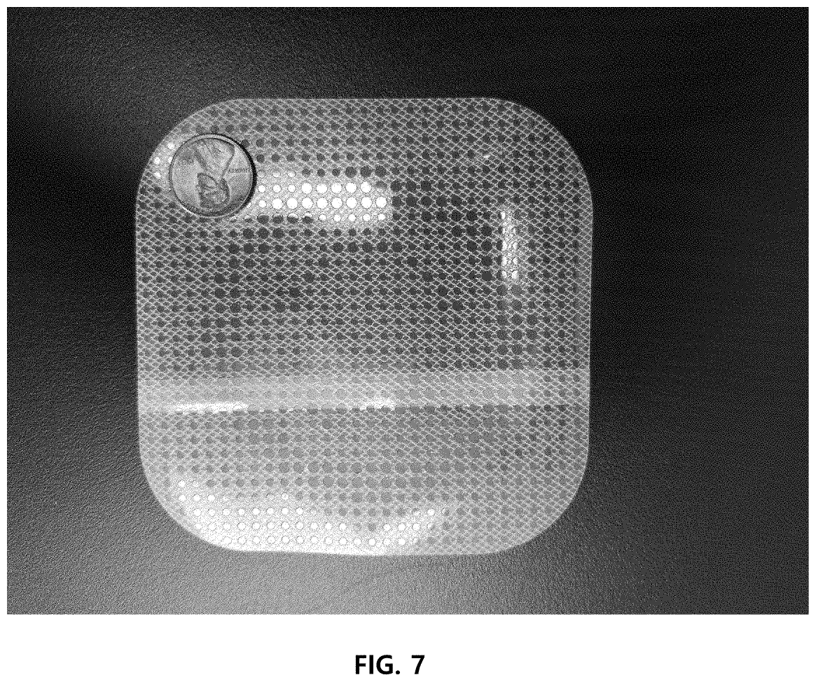

Referring to FIGS. 1-7, and specifically FIG. 6, for example, the laser system and methods described herein can also be used to form “donuts” in the materials described herein, including silicone adhesives and hydrogel materials. In the prior art, such “donuts” are made by dispensing the material around a hole, in a manner similar to depositing a glue. However, as illustrated in FIG. 6, the “donut” shape, the aperture with a raised perimeter wall, is formed using a laser system and method as described here.

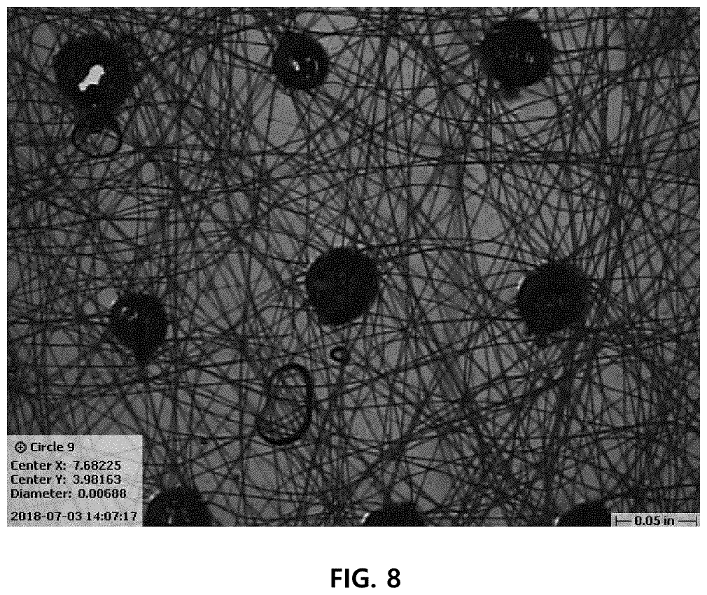

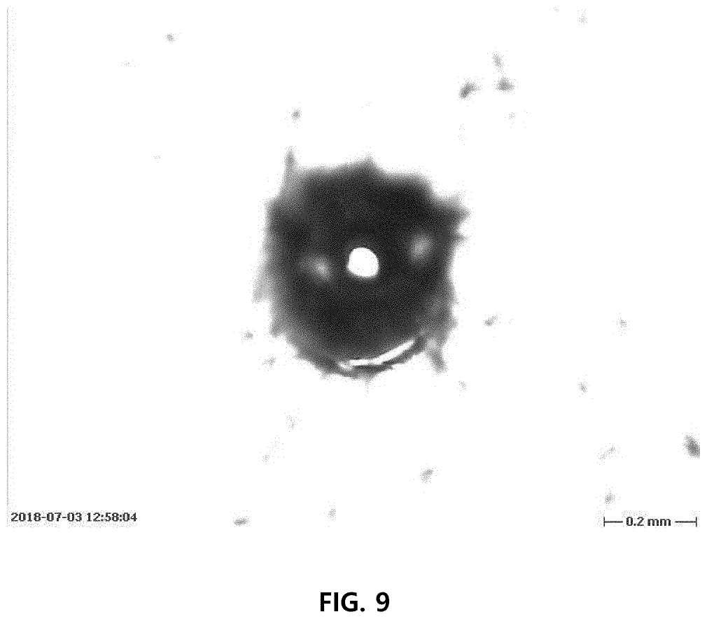

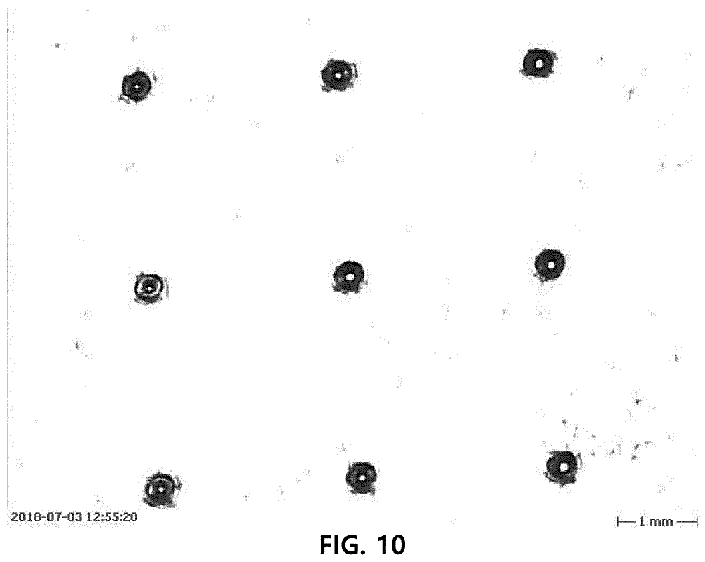

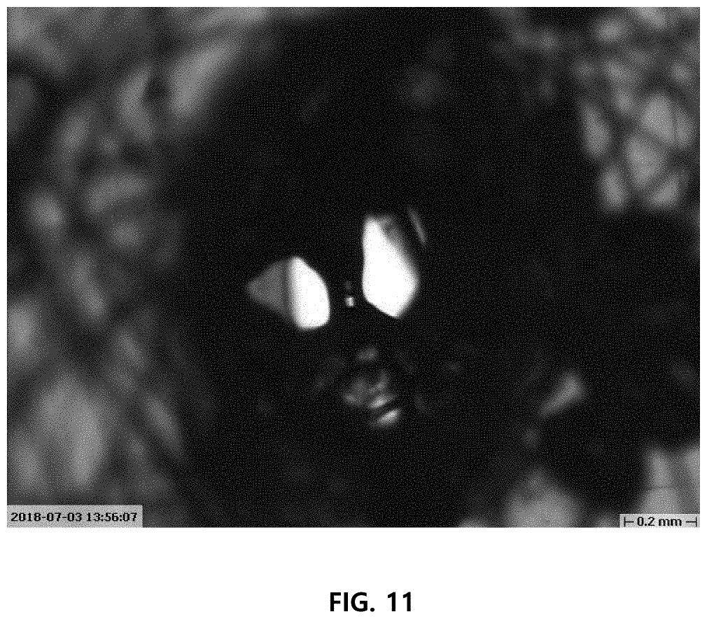

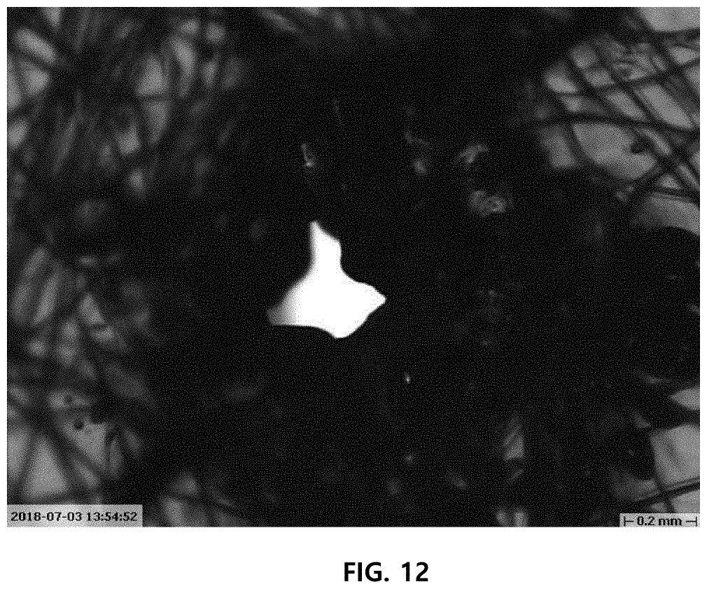

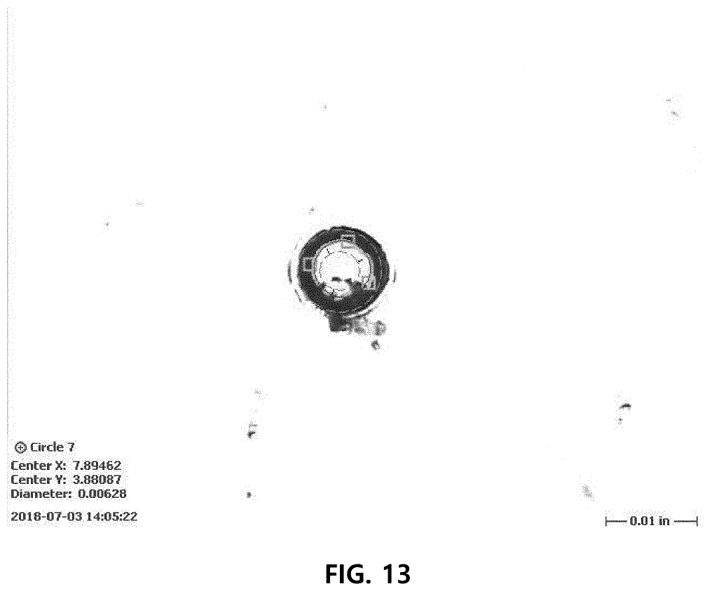

Referring to FIGS. 8-13, the prior art method of forming holes in a gel material, e.g., using “pins” is compared to the use of laser energy as described herein. It can be seen that the holes formed by the methods described herein are precise and retain their shape, whereas the holes formed by pins have uneven edges and the gel material flows to refill the hole. To make the pin perforations in FIGS. 8, 11 and 12, a 1 mm (1000 micron) pin was used and the resulting holes were significantly smaller and so irregular that the holes were difficult to measure for purposes of diameter and wall thickness. Attempting to produce laser holes in the same or substantially same diameter in the same thickness of hydrogel material, the laser produced holes, as illustrated in FIGS. 9, 10 and 13 were approximately 50 micron in diameter and have clean edges and are substantially round. Referring specifically to FIG. 13, pressure was applied to “squish” or cause the holes made with laser in the hydrogel to reflow and close but the holes remained intact. The cauterizing effect of the laser beam caused the holes to re-open and remain open after a short time.

It is also noted that the laser methods described herein for producing holes and other shapes in the various gel and adhesive materials described herein produces body contact sensors and/or wound care devices that have an improved performance when worn. For example, as the holes and shapes formed in the gel or adhesive materials via laser processing include a cauterized perimeter that retains the shape and inner cavity of the hole or shape, these sensors or devices can bend or move when worn without compressing or closing the holes. For applications such as bandages, the laser processed gel and/or adhesive materials then do not suffer from a reduction in capacity for holding fluid when worn by a user, especially when the bandage is wrapped around a wound (e.g., around an arm, or leg rather than a flat surface). This also allows a body contact sensor to retain conductivity when worn during activity or on a non-flat surface of a user.

As used herein, the term hydrocolloid refers to a hydrocolloid that is capable of being used in wound care dressings and devices, and/or refers to a hydrocolloid that can sufficiently withstand discoloration (from heating). The hydrocolloid is a substance that produces a gel with water and is able absorb fluids while also having an adhesion characteristic.

As used herein, the term “cauterize” or “cauterizing” refers to a wall or perimeter formed by the laser and sufficient to retain the surrounding material, the surrounding material being the same material as the wall material. When subjected to sufficient heat, the material forms a more rigid wall and/or a seal. Essentially, the wall formed is a barrier that prevents the reflow of the hydrocolloid, hydrogel or silicone adhesive so that the perforation that was formed thus retains its shape.

In the method described herein, the digital laser process is used to laser perforate the hydrogel material in a non-contact manner. This non-contact processing method allows the hydrogel materials to be cut into shapes and/or perforated with holes having a size otherwise not possible to achieve by conventional mechanical converting methods.

What is claimed:

1. A method of forming one or more perforations, holes, or capillaries in a material in a non-contact manner comprising directing a focal point of a laser beam to a surface of the material and vaporizing the material at one or more locations to form one or more perforations, holes, or capillaries having a selected diameter, wherein the material is one of a hydrogel material, a hydrocolloid material, or a silicone adhesive.

2. The method of claim 1, wherein the material comprises a wound care dressing or component.

3. The method of claim 1, wherein the material comprises a body contact sensor.

4. The method of claim 1, wherein a laser energy of the laser beam is sufficient to cauterize the material when forming the one or more perforations, holes, or capillaries such that the one or more perforations, holes, or capillaries substantially retain their laser processed shape and diameter and resist closing.

5. A method of forming one or more perforations, holes, or capillaries in an adhesive material comprising directing a focal point of a laser beam to a surface of the adhesive material and vaporizing the adhesive material at one or more locations to form one or more perforations, holes, or capillaries having a selected diameter.

6. The method of claim 5, wherein the adhesive material is one of a hydrogel adhesive or a silicone adhesive.

7. The method of claim 5, and providing a wound care dressing comprising the perforated adhesive.

8. The method of claim 7, and providing a wound care dressing comprising the perforated adhesive in contact with an exudate holding mechanism.

9. The method of claim 8, wherein the exudate holding mechanism is an open cell foam material such as polyurethane foam.

10. The method of claim 5, wherein a laser energy of the laser beam is sufficient to cauterize the adhesive material when forming the one or more perforations, holes, or capillaries such that the one or more perforations, holes, or capillaries substantially retain their laser processed shape and diameter and resist closing.

11. A method of cauterizing a material with a laser beam for forming one or more perforations, holes, or capillaries in the material in a non-contact manner comprising directing a focal point of a laser beam to a surface of the material and vaporizing the material at one or more locations to form one or more perforations, holes, or capillaries having a selected diameter, and cauterizing a perimeter of the one or more perforations, holes, or capillaries so that the one or more perforations, holes, or capillaries retains its shape and diameter, wherein the material is one of a hydrogel material, a hydrocolloid material, or a silicone adhesive.

12. The method of claim 11 wherein the laser beam has a wavelength in the range of about 5 micron to about 10 micron or greater.

13. The method of claim 11 wherein the laser beam has a wavelength set to about 5 micron and the perforations, holes, or capillaries produces have a diameter of about 85 micron or less.

14. The method of claim 11 wherein the laser beam has a wavelength selected from one of about 10.6 micron, about 10.2 micron, and about 9.36 micron and the perforations, holes, or capillaries produces have a diameter of about 85 micron or greater.
